(19) United States
(12) Patent Application Publication
(10) Pub. No.: US 2015/0213487 A1
(43) Pub. Date: Jul. 30, 2015

(54) Methods and systems for advertising using scrollable refresh trigger

(71) Applicant: ARIZE NWOSU, Los Angeles, CA (US)

(72) Inventor: ARIZE NWOSU, Los Angeles, CA (US)

(21) Appl. No.: 14/162,775

(22) Filed: Jan. 24, 2014

(51) Int. Cl. G06Q 30/02; G06F 3/0485

(52) U.S. Cl. CPC G06Q 30/0246; G06F 3/0485

(57) ABSTRACT

One aspect of the invention provides an advertising system using a user interface mechanism technically referred to as a ‘scrollable refresh trigger’ also known as a ‘pull-to-refresh’, to deliver advertisement. The invention presents improved methods, systems, computer readable media and apparatuses for providing responsive advertising using a scrollable refresh trigger. In at least one instance, a scrollable refresh trigger may be activated. Subsequently an advertisement may be received for embedding and display with a scrollable refresh trigger and stored. In response to a request received for sending an advertisement for embedding and display with a scrollable refresh trigger to a web browser operating on a client, an advertisement may be selected and sent to the web browser for display as part of a scrollable refresh trigger on a web page. In one arrangement, a pull-to-refresh the content items subsequently exposing the advertisement verifies a user has received an impression of the advertisement. Once the scrollable refresh trigger has been activated and the advertisement exposed, a receipt of an impression of the advertisement may be recorded. Additionally the awareness of an advertisement may be measured for a target audience and reported to advertisers. In various embodiments, a click on the exposed advertisement may result in the user being sent/transferred to the advertisers content which may take the form of but not limited to text, image, rich media, expandable media, game, video, audio clip, phone number for click-to-call or other multi-media. Additionally, the click through rate (CTR) or conversion rate (CR) of an advertisement may be measured for a target audience and reported to advertisers.

### CROSS-REFERENCE TO RELATED APPLICATIONS

This application claims priority to and the benefit to U.S. Provisional Patent Application Ser. No. 61/760,084, filed Feb. 3, 2013 and entitled “Scrollable Refresh Trigger Advertising” under 35 U.S.C. §119(e). The entire content of the above-referenced provisional patent application is hereby incorporated by reference herein for all purposes.

### BACKGROUND

1. Field of the Invention

The invention relates generally to computer systems, and more particularly to an improved system and method for providing and using a user interface mechanism that includes a scrollable refresh trigger also commonly known as ‘pull-to-refresh’ to deliver advertising. The scrollable refresh trigger may be similar to the one described in U.S. patent application Ser. No. 12/756,574 (incorporated herein by reference), entitled “USER INTERFACE MECHANICS,” filed on Apr. 8, 2010 and listing Loren Brichter as inventor.

2. Description of the Related Art

Advertising systems that may offer to sell a customer's products online may provide an infrastructure for completing a sales transaction. A user presented with the advertisement may click the ad in order to be taken to a web page provided by the advertiser to complete a sales transaction. Typically, the advertiser pays by the click or impression, and, in order to measure the effectiveness of the ad, must track the users who arrive at the provided web page to determine how many go on to complete the transaction. This tracking is well within the capabilities of sophisticated advertisers.

However, online advertising systems lack the infrastructure to measure awareness of online “brand”, or “awareness”/“recall” advertising. Advertisers often use media advertisement in order to perform “brand” or “awareness”/“recall” advertising with the goal of increasing the awareness of the advertiser or of a certain product or brand among users from a certain group. Unlike the pay-per-click model applied to advertising to sell a customer's products online, media advertisement used to perform “brand” or “awareness” advertising are typically paid for by impression; that is, a fee is paid whenever the advertisement is shown. This pricing model is natural given that the goal of the advertiser is to improve awareness and brand recall. The advertiser wishes for users to see the advertisement, and the advertiser hopes that, over time, users from a particular group will have increased awareness of the brand as a result of the brand advertising campaign.

Unfortunately, current online advertising systems performing brand advertising not only fail to provide a way to measure the effectiveness of advertising, many systems fail to verify that a human has received an advertisement, rather than an online agent for instance. Because a user need not express any interest in the advertisement to generate a charge to the advertiser, few systems attempt to verify that a human has received an advertisement. Some systems may employ banner advertisements that verify that a user has clicked on a particular location to verify the presence of a person. These banner advertisements are usually in the form of a game, such as shooting targets animated in the banner advertisement to appear moving around that a user may click on to signify the presence of a person. However, such techniques fail to measure any awareness of the advertiser or of a certain product or brand of the advertiser.

As a result, it's difficult to infer the return on investment of an online brand advertising campaign. Due to the uncertainty of the return on investment, advertisers may place a lower value on online brand advertising than they might otherwise. What is needed is an online advertising system and method that may measure awareness of online brand advertising. Such a system and method should be able to verify that a user has received an online brand advertisement.

### SUMMARY

Briefly, the present invention may provide a system and method for providing and using a user interface mechanism known as a scrollable refresh trigger for advertising. A scrollable refresh trigger advertising server may provide services for providing and using a scrollable refresh trigger for advertising, including services for sending an advertisement for embedding and display with a scrollable refresh trigger on a web browser operating on a client. The scrollable refresh trigger advertising server may also include an operably coupled scrollable refresh trigger ad selector for selecting an advertisement for display with a scrollable refresh trigger, for instance, by a web browser as part of a web page. The scrollable refresh trigger advertising server may further include an operably coupled response validator for verifying that a response (a pull-to-refresh the content items and/or a click to the advertisement embedded/displayed with the scrollable refresh trigger) to the advertisement displayed with the scrollable refresh trigger has been made. Additionally, the scrollable refresh trigger advertising server may include an operably coupled measurement comparator for measuring awareness and recall of advertisement by target audiences.

The present invention may provide a framework for providing and using a scrollable refresh trigger for advertising. An advertisement may be received for embedding and display with a scrollable refresh trigger, and stored for use in advertising. In response to a request received for sending an advertisement for embedding and display with a scrollable refresh trigger on a web browser operating on a client, an advertisement may be selected and sent to the web browser for display with a scrollable refresh trigger as part of a web page. And the user may be prompted to “pull-to-refresh” the content items display. Once the scrollable refresh trigger has been activated, a receipt of an impression of the advertisement embedded/displayed with the scrollable refresh trigger may be recorded. Furthermore upon clicking on the advertisement embedded/displayed with the scrollable refresh trigger, a receipt of a click of the advertisement may be recorded.

Additionally, the framework of the present invention may be used to measure the awareness of an advertisement for a target audience. In response to individual requests received from a subset of members of a target audience for sending an advertisement for embedding and display with a scrollable refresh trigger, an advertisement may be selected and sent for embedding and display with a scrollable refresh trigger to the subset of members of the target audience in response to their individual requests for display as part of a web page. The subset of members of the target audience may be prompted to input a response to a question about the displayed advertisement to measure their awareness of the displayed advertisement and the receipt of an impression may be recorded for valid responses from the subset of members of the target audience. Another subset of members of the target audience not sent the advertisement may be prompted to input a response to a question about the advertisement to measure awareness of the advertisement and the receipt of an impression may be recorded for valid responses from this subset of members of the target audience who were not sent the advertisement. The measurements of awareness for the two subsets of the target audience may be compared, and the difference may be reported to an advertiser in various embodiments as a measure of effectiveness of an online advertising campaign.

Advantageously, the present invention may effectively measure the impact of an advertising campaign on brand awareness over time. In an embodiment, measurements of an advertising campaign may be periodically reported to advertisers to provide a view of the effectiveness of the advertising campaign on brand awareness over time. Moreover, measurements of a particular advertising campaign may be compared to measurements of another advertising campaign for determining the effectiveness of a particular advertising campaign. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated in accordance with one or more aspects described herein in the present invention;

FIG. 2 is a block diagram generally representing an exemplary architecture of system components for providing and using scrollable refresh triggers to deliver advertising, in accordance with one or more aspects described herein in the present invention;

FIG. 3-5 illustrate example user interfaces by which a scrollable refresh trigger with an embedded advertisement may be displayed in accordance with one or more aspects described herein in the present invention;

FIG. 6 is a flowchart for generally representing the steps undertaken in one embodiment for generating an advertisement for embedding/display with a scrollable refresh trigger, in accordance with one or more aspects described herein in the present invention;

FIG. 7 is a flowchart for generally representing the steps undertaken in one embodiment for delivering an advertisement using a scrollable refresh trigger with an embedded advertisement, in accordance with an aspect of the present invention;

FIG. 8 is a flowchart for generally representing the steps undertaken in one embodiment for verifying receipt of an impression of an advertisement delivered using a scrollable refresh trigger, in accordance with one or more aspects described herein in the present invention;

FIG. 9 is a flowchart for generally representing the steps undertaken in one embodiment for measuring the awareness of an advertisement delivered using a scrollable refresh trigger, in accordance with one or more aspects described herein in the present invention;

FIG. 10 is a flowchart for generally representing the steps undertaken in one embodiment for delivering an advertisement using a scrollable refresh trigger with an embedded advertisement to a subset of a target audience, in accordance with one or more aspects described herein in the present invention; and

FIG. 11 is a flowchart for generally representing the steps undertaken in one embodiment for verifying receipt of an impression of an advertisement delivered using a scrollable refresh trigger to a subset of a target audience, in accordance with one or more aspects described herein in the present invention.

### DETAILED DESCRIPTION

### Exemplary Operating Environment

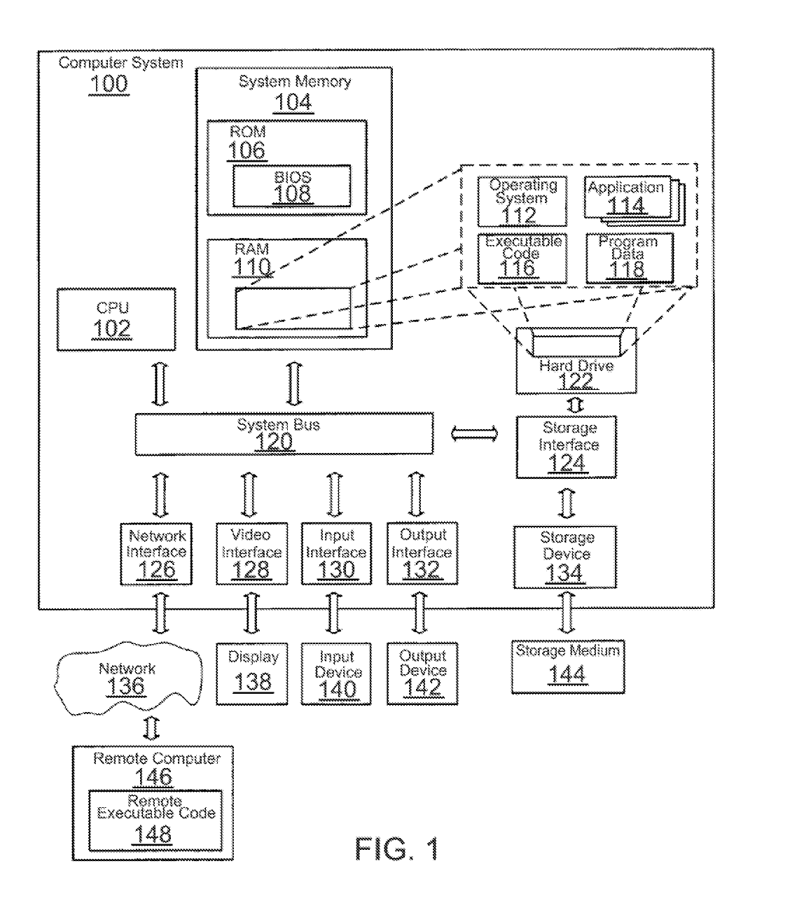

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed in and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described in relative to the computer system 100. The network 136 depicted in FIG. 1 may include a local area network (LAN), a wide area network (WAN), a mobile network, or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Providing Scrollable Refresh Trigger for Online Advertising

The present invention is generally directed towards a system and method for providing and using a scrollable refresh trigger for online advertising. A scrollable refresh trigger, as used herein, may mean or usually refer to methods, computer readable media, and apparatuses for providing enhanced user interface mechanics. In one arrangement, a scrollable list of content items may be displayed. Input associated with a scroll command may be received. Then, based on the scroll command, a scrollable refresh trigger may be displayed. Subsequently, the scrollable list of content items may be refreshed in response to determining, based on the scroll command, that the scrollable refresh trigger has been activated. In at least one instance, it may be determined that the scrollable refresh trigger has been activated in response to determining that the scroll command was completed while the scrollable refresh trigger was fully displayed.

The present invention provides and uses scrollable refresh trigger to convey advertisements for advertising by embedding and displaying a message such as an advertisement or a brand awareness with a scrollable refresh trigger. For example, a scrollable refresh trigger may be embedded with an advertisement message from the brand; “NIKE (Just do it)”. Input associated with a scroll command may be received. Then, based on the scroll command, a scrollable refresh trigger may be displayed with an embedded Nike advertisement with it. Subsequently, the scrollable list of content items may be refreshed in response to determining, based on the scroll command, that the scrollable refresh trigger has been activated and this may be measured as an awareness of the Nike brand.

As will be seen, the framework of the present invention may be used to verify that a user has received a brand advertisement and may also be used to measure the awareness of an advertisement for a target audience. As will be understood, the various block diagrams, flow charts and scenarios described herein are only examples, and there are many other scenarios to which the present invention will apply.

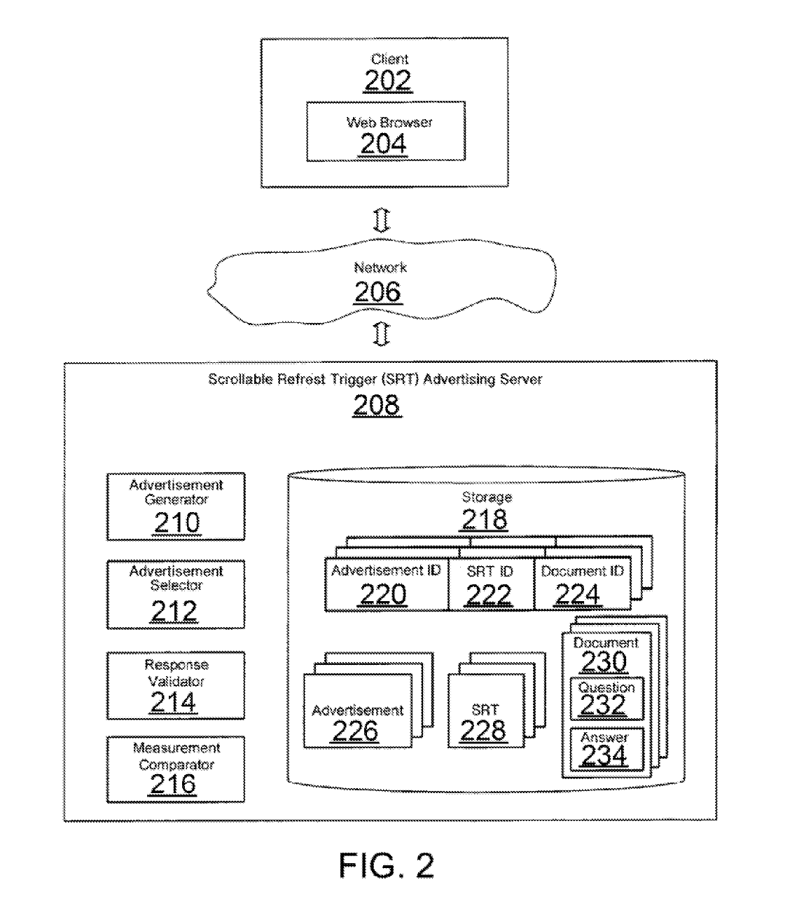

Turning to FIG. 2 of the drawings, there is shown a block diagram generally representing an exemplary architecture of system components for providing and using scrollable refresh triggers for advertising. Those skilled in the art will appreciate that the functionality implemented within the blocks illustrated in the diagram may be implemented as separate components or the functionality of several or all of the blocks may be implemented within a single component. For example, the functionality for the response validator 214 may be included in the same component as the measurement comparator 216. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), a mobile network, or other type of network. A web browser 204 may execute on the client computer 202 and may include functionality for receiving a web page requested by a user.

The web browser may send a request for a web page to a web page server. When a request may be received by a web page server to serve a web page, the web page server may determine that the web page requested may include a web page placement for a scrollable refresh trigger. The web page server may then request an advertisement to be embedded/displayed in a scrollable refresh trigger from a scrollable refresh trigger advertising server to send to a web browser operating on a client so that the scrollable refresh trigger with an embedded advertisement may be displayed as part of the web page by the web browser 204. In various embodiments, a user may be requested to “pull-to-refresh” the content displayed on the web page. In general, the web browser 204 may be any type of interpreted or executable software code such as a kernel component, an application program including but not limited to mobile and web applications, a script, a linked library, an object with methods, and so forth.

The scrollable refresh trigger advertising server 208 may be any type of computer system or computing device such as computer system 100 of FIG. 1. In general, the scrollable refresh trigger advertising server 208 may provide services for providing and using scrollable refresh triggers for advertising, including services for receiving a request to send an advertisement for embedding and display with a scrollable refresh trigger to a web browser operating on a client for display as part of a scrollable refresh trigger on a web page and services for sending the advertisement for embedding and display with a scrollable refresh trigger to the web browser. In various embodiments, the scrollable refresh trigger advertising server 208 may also provide services for receiving responses from a target audience responding to a question about an advertisement displayed to the target audience as part of a scrollable refresh trigger on a web page. In particular, the scrollable refresh trigger advertising server 208 may include an advertisement generator 210 for generating an advertisement for embedding and display with a scrollable refresh trigger. The scrollable refresh trigger advertising server 208 may also include an advertisement selector 212 for selecting an advertisement for embedding and display with a scrollable refresh trigger, for instance, by a web browser as part of a web page. The scrollable refresh trigger advertising server 208 may further include a response validator 214 for verifying that a response (a pull-to-refresh content and/or a click to the advertisement embedded/displayed with the scrollable refresh trigger) may be valid. Additionally, the scrollable refresh trigger advertising server 208 may include a measurement comparator 216 for measuring awareness of online advertising by target audiences. Each of these modules may also be any type of executable software code such as a kernel component, an application program including but not limited to mobile and web applications, a linked library, an object with methods, or other type of executable software code.

The scrollable refresh trigger advertising server 208 may be operably coupled to a database of information about the advertisements embedded/displayed with a scrollable refresh trigger used for advertising such as storage 218. Storage 218 may include advertisements 226 that may be embedded/displayed with a scrollable refresh trigger 228 and may have associated documents 230 that may include one or more texts 232 about an advertisement and answers 234 that may be valid responses to the questions. An advertisement ID 220 referencing an advertisement 226 may be associated with a scrollable refresh trigger (SRT) ID 222 referencing a scrollable refresh trigger 228 that may include the advertisement 226 embedded/displayed with it, and the advertisement ID 220 and the scrollable refresh trigger (SRT) ID 222 may also be associated with a document ID 224 referencing a document 230 that may include one or more texts 232 relating to a advertisement. In various embodiments, the scrollable refresh trigger (SRT) 228 referenced by the scrollable refresh trigger (SRT) ID 222 may also include embedded in its advertisement one or more of texts 232 relating to a advertisement 226 embedded in the scrollable refresh trigger (SRT). Any type of advertisements 226 may be embedded in a scrollable refresh trigger (SRT) 228.

In general, marketing personnel may generate marketing material, including advertisements, intended to convey a marketing message. The marketing material may take the form of but not limited to text, image, rich media, expandable media, game, video, audio clip, or other multi-media embodiment. The marketing personnel may also generate texts related to the marketing material that may be used to validate the receipt of the intended marketing message. Typically, a pull-to-refresh the content items and/or a click to the advertisement embedded/displayed with the scrollable refresh trigger with or without text relating to the embedded/displayed advertisement may be counted as receipt of the intended marketing message.

When an advertisement for embedding and display with a scrollable refresh trigger may be needed, an advertisement may be chosen as well as a corresponding text. The advertisement embedded/displayed with a scrollable refresh trigger including text related to the embedded/displayed advertisement may be presented to the user. With a pull-to-refresh the content items and/or a click to the advertisement embedded/displayed with the scrollable refresh trigger with or without text relating to the embedded/displayed advertising, the scrollable refresh trigger advertising server will report a successful receipt of the marketing message. Advertisers may then be billed according to the number of successfully received marketing messages.

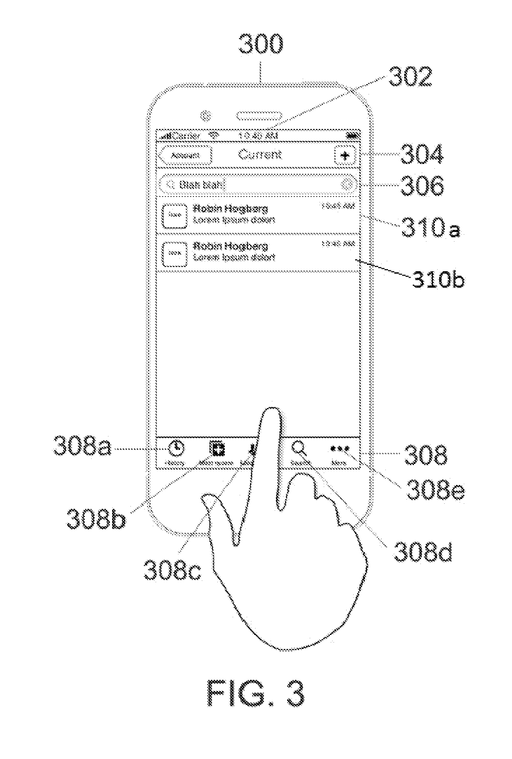

FIGS. 3-5 illustrate sample user interfaces by which an advertisement may be embedded/displayed with a scrollable refresh trigger according to one or more aspects described herein. According to one or more aspects, the user interfaces described herein, such as the user interfaces illustrated in FIGS. 3-5, may be implemented in, displayed by, and/or used in conjunction with a computing device, such as computing device 300.

As illustrated in FIG. 3, a computing device, such as computing device 300, may display user interface 302. User interface 302 may include a header bar 304, a search bar 306, a menu bar 308, and a scrollable list of content items 310. The scrollable list of content items 310 may include one or more content items, such as content items 310a and 310b.

According to one or more aspects, header bar 304 may include one or more buttons that allow a user to select and/or log into and/or out of an account associated with a content provider, such as a social media service (e.g., TWITTER, FACEBOOK, INSTAGRAM, VINE, GOOGLE+, etc.), and/or allow a user to create a new content item associated with such a content provider. Search bar 306 may allow a user to search the scrollable list of content items 310 (e.g., for content items that include particular keywords). Menu bar 308 may include one or more buttons that provide various functionalities.

For example, menu bar 308 may include a ‘History’ button 308a, which may allow a user to view a scrollable list of content items that includes content items previously displayed (e.g., status updates and/or other posts from users that the user may follow). Menu bar 308 further may include a ‘Most Recent’ button 308b, which may allow a user to view a scrollable list of content items that include the most recent content received (e.g., status updates and/or other posts from users that the user may follow). Menu bar 308 further may include a ‘Most Viewed’ button 308c, which may allow a user to view a scrollable list of content items that include content items that are most viewed by users on the network (e.g., status updates and/or other posts from users that the user may follow). Menu bar 308 further may include a ‘Search’ button 308d, which may allow a user to search a network and/or a database (e.g., a database of content items) for additional content items, geographically nearby users, other users, saved keywords, and/or trending topics. Menu bar 308 further may include a ‘More’ button 308e, which may allow a user to edit his or her profile (e.g., the user's profile associated with the particular content provider, such as their TWITTER profile or FACEBOOK profile); view his or her favorite content items; view and/or edit drafts of content items that the user has created; and/or view, create, and/or edit lists of users (e.g., lists of users that the user may subscribe to and/or follow).

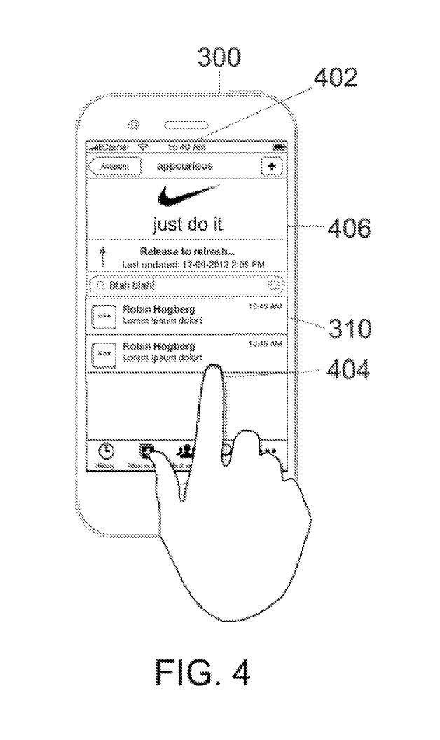

As illustrated in, FIG. 4, a computing device, such as computing device 300, may display user interface 402, and further may receive touch-based user input, as represented by touch point 404. Touch point 404 may represent a point on a touch screen included in computing device 300 where a user has put a finger down on the touch screen. Stated differently, touch point 404 may represent a place on the touch screen where the user is touching and/or otherwise in contact with the touch screen (e.g., with a stylus, etc.).

In FIG. 4, for example, the user has put a finger down on touch point 404, which, in this example, is a point corresponding to the scrollable list of content items 310. By subsequently sliding his or her finger along the touch screen (e.g., by sliding the touch point 404 downward), the user may initiate a scroll command, which may result in the scrollable list of content items 310 being scrolled, which is reflected by the downward shift in the scrollable list of content items 310. In addition, as the scrollable list of content items 310 is scrolled, a scrollable refresh trigger with an embedded/displayed advertisement 406 may be revealed and/or displayed. In this example the advertisement embedded/displayed with the scrollable refresh trigger 406 may include an advertisement message for the brand; “NIKE (just do it)”. There may be several advertisement messages included in an advertisement embedded/displayed with the scrollable refresh trigger 406.

The scrollable refresh trigger with an embedded advertisement 408 may scroll with one or more content items included in the scrollable list of content items 310, and the scrollable refresh trigger with an advertisement embedded/displayed with it 406 may be adjacent to a displayed or un-displayed content item included in the scrollable list of content items 310. Thus, as the scrollable list of content items 310 is scrolled in accordance with the scroll command, the scrollable refresh trigger with an embedded/displayed advertisement 406 also may be scrolled.

As a user continues to scroll the scrollable list of content items 310 (e.g., by continuing to slide the touch point 404 downward along the touch screen), the computing device 300 may display user interface 402.

As may be seen in FIG. 4, the continued scrolling of the scrollable list of content items 310 may result in the continued scrolling of the scrollable refresh trigger with an embedded advertisement 406, which also may result in a greater portion of the advertisement embedded/displayed with the scrollable refresh trigger 406 being displayed by the computing device 300.

As may be seen in FIG. 4, the continued scrolling of the scrollable list of content items 310 may result in the continued scrolling of the scrollable refresh trigger with an embedded advertisement 406, which also ultimately may result in the advertisement embedded in the scrollable refresh trigger 406 being fully displayed by the computing device 300.

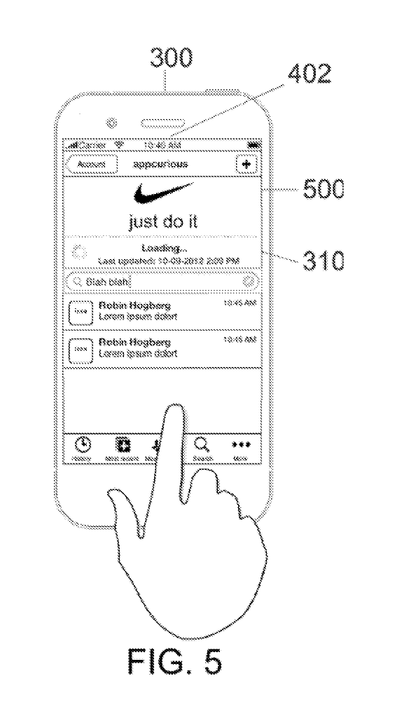

As may be seen in FIG. 5, after the user lifts up his or her finger from touch point 404 on the touch screen or otherwise completes the scroll command, the advertisement embedded/displayed with the scrollable refresh trigger 406 disappears upwards and a status description 500 may be displayed. Status description 500 may state, for instance, “Loading” to inform the user that computing device 300 is refreshing the scrollable list of content items 310 and/or loading new data (e.g., downloading recent and/or unread content items from a remote server, such as a TWITTER or FACEBOOK server).

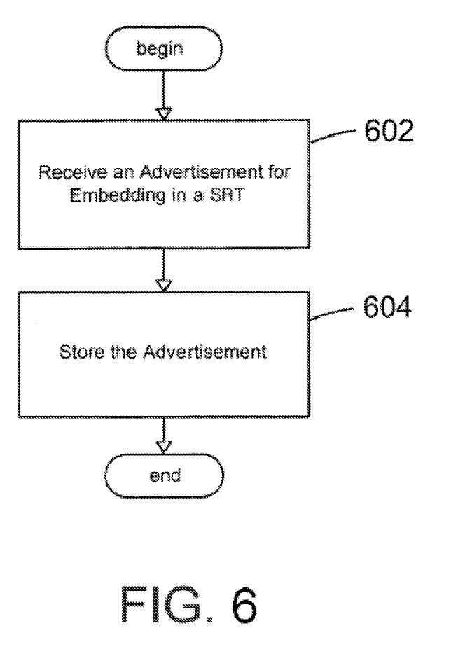

FIG. 6 presents a flowchart for generally representing the steps undertaken in one embodiment for generating a scrollable refresh trigger with an embedded advertisement. An advertisement may be received for embedding in a scrollable refresh trigger at step 602. The advertisement may be any type of advertisement or components of an advertisement including but not limited to text, image, rich media, expandable media, game, video, audio clip, or other multi-media embodiment. In an embodiment, the advertisement may include but not limited to text, image, rich media, expandable media, game, video, audio clip, or other multi-media embodiment, presenting a message. (FIG. 4 includes the advertisement message for the brand; “NIKE (just do it)”.)

The advertisement for embedding/display with a scrollable refresh trigger may be stored at step 604 and processing may be finished for generating an advertisement for embedding/display with a scrollable refresh trigger. In addition to storing the advertisement, the advertisement may be stored and a document with the text relating to the advertisement may be stored as illustrated in FIG. 2. In an embodiment, the advertisement may be embedded/displayed with a scrollable refresh trigger without embedding a text related to the advertisement.

There may be many applications which may use the present invention for conveying marketing messages using scrollable refresh trigger. Any application which may require a user to pull-to-refresh the content items may use the present invention to generate and send an advertisement for embedding/display with a scrollable refresh trigger. For instance, the content area may include a chronologically-arranged listing of personal status updates, blog entries, micro-blogging posts (e.g., tweets and/or other status updates associated with TWITTER, photo updates associated with INSTAGRAM, status updates associated with FACEBOOK, video updates associated with VINE, etc.), news headlines, news articles, text, images, audio, video, links, and/or other content items. A scrollable refresh trigger with embedded advertisements may be advantageously used to deliver a brand advertisement without interrupting the content. Moreover, the present invention may also be used to verify that an impression of the marketing message has been received by a human being.

### Delivering Advertisements Using Scrollable Refresh Trigger

The present invention is also generally directed towards a system and method for delivering advertisements using a scrollable refresh trigger with an embedded advertisement. In an embodiment, delivering marketing messages using scrollable refresh trigger may be offered as service to Internet web sites, mobile web sites, enterprise software systems, internet applications, mobile applications, standalone applications, and other services. Such a service may generate advertisements for web sites, applications, any computer readable media and user interface.

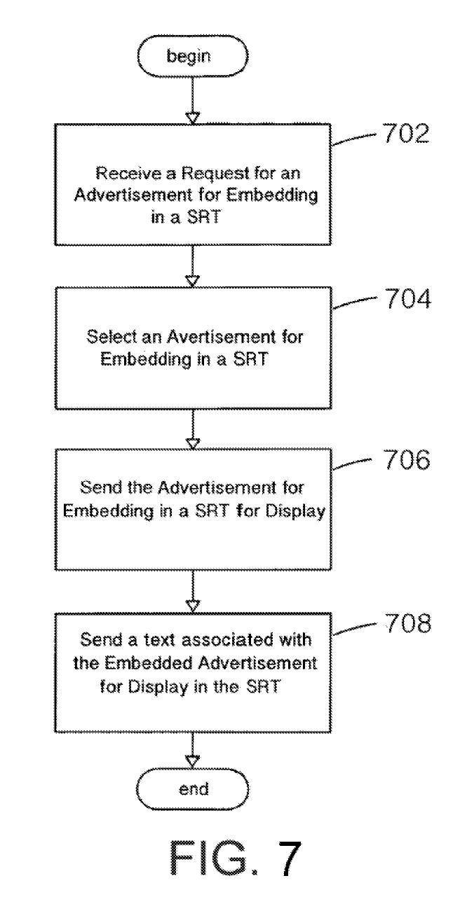

FIG. 7 presents a flowchart for generally representing the steps undertaken in one embodiment for delivering an advertisement using a scrollable refresh. A request for an advertisement for embedding/display with a scrollable refresh trigger may be received at step 702. For instance, a request may be received by a web page server to serve a web page that may include a scrollable refresh trigger with an embedded advertisement. The web page server may then request an advertisement for embedding/display with its scrollable refresh trigger from a scrollable refresh trigger advertisement server to send to a web browser operating on a client so that the scrollable refresh trigger with an embedded advertisement may be displayed as part of the web page on a client browser. At step 704, an advertisement for embedding in a scrollable refresh trigger may be selected. In various embodiments, a request for an advertisement for embedding/display with a scrollable refresh trigger may also include a target ID for referencing a target or group of visitors that may be defined by a profile of characteristics that may match a visitor of the web page. For example, a profile may use characteristics such as demographic information including gender, age, or surfing behavior. In an embodiment, the advertisement selector, described in conjunction with FIG. 2, may select an advertisement for embedding/display with a scrollable refresh trigger that may be associated with the target ID.

Upon selecting an advertisement for embedding/display with a scrollable refresh trigger, the advertisement may be sent at step 706 to a web browser operating on a client so that a scrollable refresh trigger with the embedded advertisement may be displayed as part of the web page on a client browser. In some embodiments, a text relating to the advertisement may also be embedded into a scrollable refresh trigger with embedded advertising that may be displayed. In these embodiments, executable or interpreted code for a text relating to the embedded/displayed advertisement may be sent to the web browser so that a scrollable refresh trigger may be displayed by the web browser with text corresponding to the advertisement embedded/displayed in the scrollable refresh trigger. In various other embodiments where the advertisement may be embedded into a scrollable refresh trigger without embedding a text related to the embedded advertisement in the scrollable refresh trigger, a default text prompting the user to “pull to refresh” or “slide to refresh” the content items may also be sent at step 708 for display. In such embodiments, executable or interpreted code for the text relating to the embedded advertisement may be sent to the web browser along with the advertisement for embedding/display in the scrollable refresh trigger so that the text may be presented in the scrollable refresh trigger to the user prompting a pull or slide action which may be recorded as a response to the advertisement embedded/displayed with the scrollable refresh trigger. After sending the advertisement to be embedded/displayed with the scrollable refresh trigger and a text relating to the embedded advertisement, processing may be finished for delivering an advertisement using a scrollable refresh trigger with an embedded advertisement.

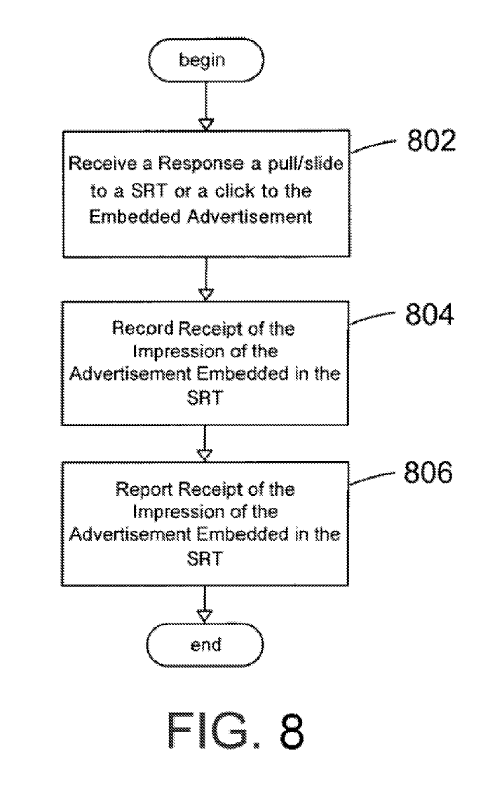

Additionally, verification of receipt of an impression may be provided using a scrollable refresh trigger with an embedded advertisement to deliver an advertisement. FIG. 8 presents a flowchart for generally representing the steps undertaken in one embodiment for verifying receipt of an impression of an advertisement delivered using a scrollable refresh trigger. A response to an advertisement embedded/displayed with a scrollable refresh trigger may be received at step 802. In an embodiment, a response may be received from a user prompted to “pull to refresh” or “slide to refresh” the content items using a scrollable refresh trigger displayed (or not displayed) as part of a web page by a web browser operating on a client. At step 804, receipt of an impression of the advertisement embedded/displayed with a scrollable refresh trigger may be recorded, for instance, in a measurements file. Additionally, receipt of an impression of the advertisement embedded/displayed with a scrollable refresh trigger may be reported at step 806 to an advertiser and processing may be finished for verifying receipt of an impression of an online advertisement delivered using a scrollable refresh trigger.

### Measuring Awareness of Advertising Using Scrollable Refresh Triggers

The present invention is also generally directed towards a system and method for measuring the awareness of an advertisement delivered using a scrollable refresh trigger. In general, the members of a particular target audience may be segmented into two groups. An advertising campaign may be applied to members of one of the groups by sending a scrollable refresh trigger with an embedded advertisement. The members of the other group may not be exposed to the advertising campaign and may not be sent a scrollable refresh trigger with the embedded advertisement. Thus the members of a target audience may belong to one of two groups: those exposed to the advertising campaign and those not exposed to the advertising campaign. The effectiveness of the advertising campaign may then be measured by comparing awareness measures for the two groups of the target audience.

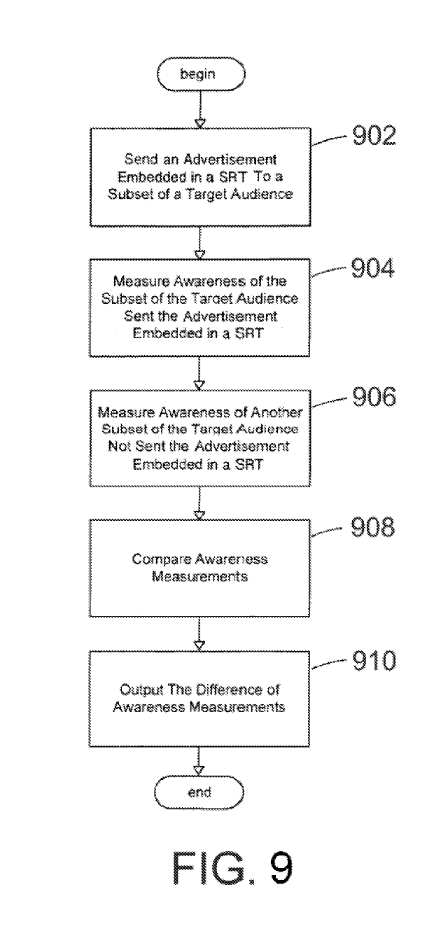

FIG. 9 presents a flowchart for generally representing the steps undertaken in one embodiment for measuring the awareness of an advertisement delivered using a scrollable refresh trigger. In general, a target audience of visitors that may be identified offline may be divided into a subset that may be sent an advertisement using a scrollable refresh trigger and a subset that may not be sent the scrollable refresh trigger with the embedded advertisement. At step 902, an advertisement for embedding/display with a scrollable refresh trigger may be sent individually when requested to a web browser operating on a client for a subset of a target audience so that the scrollable refresh trigger with the embedded advertisement may be displayed as part of a web page on the client browsers. In an embodiment, when an advertisement for embedding/display with a scrollable refresh trigger may be requested to be sent to a web browser of a member of the target audience, an advertisement for embedding and display with a scrollable refresh trigger may be selected and an indication may be recorded that the selected advertisement for embedding and display with a scrollable refresh trigger was sent to the member of the target audience. At step 904, the awareness of the advertisement embedded/displayed with the scrollable refresh trigger may be measured for the subset of the target audience sent the advertisement embedded/displayed with a scrollable refresh trigger. In various embodiments, the visitors of the web page to whom the scrollable refresh trigger with the embedded advertisement was displayed may be polled after a particular time period. In some embodiments, a question about the advertisement embedded/displayed with the scrollable refresh trigger may be sent to the web browsers of visitors prompting a visitor to input a response to the question about the advertisement. The responses to a question about the advertisement embedded/displayed with scrollable refresh trigger may be verified by comparing the answers to the question with a valid response that may be stored in a document that may include the question about the advertisement and the answer that may be a valid response to the question. For a verified response, receipt of an impression of the advertisement embedded/displayed with a scrollable refresh trigger may be recorded, for instance, in a measurements file.

At step 906, the awareness of the advertisement embedded in the scrollable refresh trigger may be measured for the subset of the target audience not sent the scrollable refresh trigger with the embedded advertisement. In various embodiments, the subset of the target audience not sent the scrollable refresh trigger with the embedded advertisement may be polled during the same time period when the subset of the target audience sent the scrollable refresh trigger with the embedded advertisement may be polled. After the awareness of the advertisement embedded/displayed with the scrollable refresh trigger may be measured for both subsets of the target audience, the awareness measurements of the subset of the target audience sent the advertisement embedded/displayed with the scrollable refresh trigger may be compared at step 908 with the awareness measurements of the subset of the target audience not sent the scrollable refresh trigger with the embedded advertisement. The difference between the awareness measurements of the two subsets may be output at step 910 and processing may be finished for measuring the awareness of an online advertisement delivered using a scrollable refresh trigger. In an embodiment, the difference between the awareness measurements of the two subsets may be output by reporting the difference between the awareness measurements of the two subsets to an advertiser.

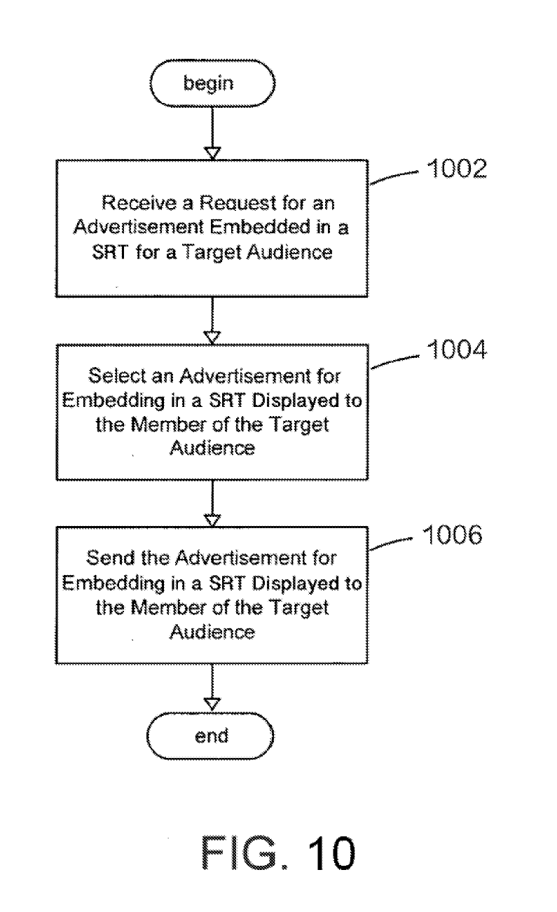

FIG. 10 presents a flowchart for generally representing the steps undertaken in one embodiment for delivering an advertisement using a scrollable refresh trigger to a subset of a target audience. At step 1002, a request for an advertisement for embedding/display with a scrollable refresh trigger may be received for a member of a subset of a target audience. An advertisement for embedding and display with a scrollable refresh trigger may be selected at step 1004 to send to the member of the subset of the target audience. At step 1006, the selected advertisement for embedding/display with the scrollable refresh trigger may be sent to the member of the subset of the target audience and processing may be finished for delivering an advertisement using a scrollable refresh trigger to a subset of a target audience.

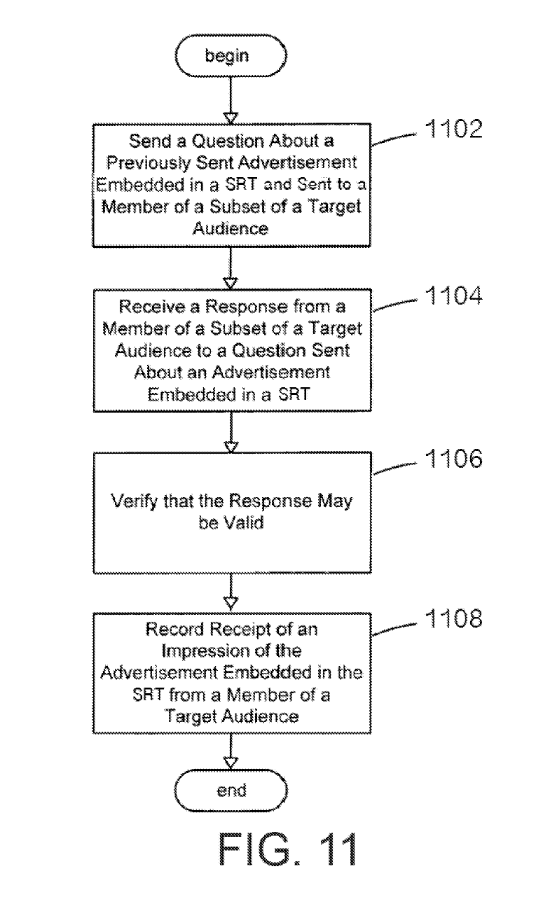

FIG. 11 presents a flowchart for generally representing the steps undertaken in one embodiment for verifying receipt of an impression of an advertisement delivered using a scrollable refresh trigger to a subset of a target audience. At step 1102, a question about a previously sent advertisement embedded/displayed with a scrollable refresh trigger may be sent to a member of a subset of a target audience. A response to the question about a previously sent advertisement embedded/displayed with a scrollable refresh trigger may be received at step 1104 from a member of a subset of a target audience. A response to a question about the advertisement embedded/displayed with the scrollable refresh trigger may be verified at step 1106 by comparing the answer to the question with a valid response that may be stored in a document that may include the question about the advertisement and the answer that may be a valid response to the question. At step 1108, receipt of an impression of the advertisement embedded/displayed with a scrollable refresh trigger may be recorded for a verified response from a member of a subset of a target audience, for instance, in a measurements file.

Thus, the present invention may use responses to polls to develop evidence of the effectiveness of awareness advertising. The results of these responses might be collected into a whitepaper or other document in an embodiment and shared with advertisers to make the case for the return on investment of an awareness advertising campaign. In an alternate embodiment, the same system may be deployed as an in-the-loop measurement system that would provide results of responses directly to advertisers for indicating how their campaigns may impact brand awareness over time. In various embodiments, the effectiveness of a particular campaign may be measured relative to other advertising campaigns, or relative to modifications of the advertising campaign.

As can be seen from the foregoing detailed description, the present invention provides an improved system and method for providing and using a scrollable refresh trigger for advertising. Such a system and method may efficiently be used to verify that a user has received a brand advertisement and may also be used to measure the awareness of an advertisement for a target audience. The system and method may apply broadly to advertising campaigns, for example, to deliver brand advertisements and measure effectiveness of the advertising campaign for increasing brand awareness. As a result, the system and method provide significant advantages and benefits needed in contemporary computing and in web and mobile applications.

While the invention is susceptible to various modifications and alternative constructions, certain illustrated embodiments thereof are shown in the drawings and have been described in in detail. It should be understood, however, that there is no intention to limit the invention to the specific forms disclosed, but on the contrary, the intention is to cover all modifications, alternative constructions, and equivalents falling within the spirit and scope of the invention.

1. A computer system for advertising, comprising: an advertisement generator for creating advertisements for embedding and display with a scrollable refresh trigger; and a storage operably coupled to the advertisement generator for storing the advertisement.

2. The system of claim 1 further comprising a scrollable refresh trigger advertising server operably coupled to the storage for providing services for using the scrollable refresh trigger with the embedded advertisement for online advertising.

3. The system of claim 1 further comprising the advertisement for embedding and display with a scrollable refresh trigger stored in the storage.

4. The system of claim 3 wherein the advertisement for embedding and display with a scrollable refresh trigger stored in the storage comprises the advertisement.

5. A computer-readable medium having computer-executable components comprising the system of claim 1.

6. A computer-implemented method for advertising, comprising: receiving an advertisement for embedding and display with a scrollable refresh trigger; and storing the advertisement in storage for use in advertising.

7. The method of claim 6 further comprising data in the form of text, images, video, or sound related to the advertisement.

8. The method of claim 7 further comprising embedding the text related to the embedded/displayed advertisement in the scrollable refresh trigger.

9. The method of claim 7 further comprising storing the text related to the advertisement in storage for use with the scrollable refresh trigger with an embedded advertisement in advertising.

10. The method of claim 6 further comprising sending the advertisement for embedding and display in the scrollable refresh trigger for display as part of a web page.

11. The method of claim 6 further comprising displaying the scrollable refresh trigger with the embedded advertisement as part of a web page.

12. The method of claim 6 further comprising receiving a target identification associated with the advertisement, the target identification referencing a group of visitors defined by a profile of characteristics.

13. The method of claim 12 wherein storing the advertisement for embedding and display in or above the scrollable refresh trigger in storage for use in advertising comprises storing an advertisement identification associated with the target identification in storage, the scrollable refresh trigger identification referencing the scrollable refresh trigger with the embedded advertisement.

14. The method of claim 9 wherein storing the text related to the advertisement in storage for use with a scrollable refresh trigger with the embedded advertisement in advertising comprises storing a document identification associated with a advertisement identification in storage, the document identification referencing a file including the text related to the advertisement and the scrollable refresh trigger identification referencing the scrollable refresh trigger with the embedded advertisement.

15. The method of claim 7 further comprising: receiving a response (a pull-to-refresh the content items and/or a click to the advertisement embedded/displayed in the scrollable refresh trigger); and storing the response in storage for use in verifying a response to the advertising.

16. A computer-readable medium having computer-executable instructions for performing the method of claim 6.

17. A computer system for advertising, comprising: means for receiving an advertisement for embedding and display with a scrollable refresh trigger; means for embedding and displaying the advertisement with the scrollable refresh trigger; and means for displaying the scrollable refresh trigger with the embedded advertisement as part of a web page.

18. The computer system of claim 17 further comprising: means for receiving a text relating the advertisement; and means for embedding the text for display in or above the scrollable refresh trigger with the embedded advertisement.

19. The computer system of claim 17 further comprising: means for receiving a text relating the advertisement; and means for storing the text in storage for use with the scrollable refresh trigger with the embedded advertisement in online advertising.

20. The computer system of claim 17 further comprising means for sending the advertisement for embedding and display in or above the scrollable refresh trigger for display as part of the scrollable refresh trigger on a web page.
